(19) United States
(12) Patent Application Publication
(10) Pub. No.: US 2022/0340782 A1
(43) Pub. Date: Oct. 27, 2022

(54) ULTRA-QUIET BACKING-PAPER-FREE COLD LAMINATING FILM AND PREPARATION METHOD THEREOF

(71) Applicant: ZHEJIANG FULAI NEW MATERIALS CO., LTD, Jiaxing, Zhejiang (CN)

(72) Inventors: Houjun XIA, Jiaxing, Zhejiang (CN); Daji TU, Jiaxing, Zhejiang (CN); Hua PAN, Jiaxing, Zhejiang (CN); Xiaoming YANG, Jiaxing, Zhejiang (CN)

(21) Appl. No.: 17/754,025

(22) PCT Filed: Nov. 22, 2019
(86) PCT No.: PCT/CN2019/120389

§ 371 Date: Mar. 22, 2022

(30) Foreign Application Priority Data
Sep. 29, 2019 (CN) 201910932557.1

(51) Int. Cl. C09J 7/20; C09J 7/24; C09J 7/25

(52) U.S. Cl. CPC C09J 7/201; C09J 7/24; C09J 7/255; C09J 2301/122; C09J 2433/001

(57) ABSTRACT

The present invention discloses an ultra-quiet backing-paper-free cold laminating film comprising a substrate layer, a release layer, and an adhesive layer, the release layer and the adhesive layer being each attached to a respective side of the substrate layer, the release layer being obtained by drying a release agent applied on the substrate layer, and the release agent consisting of the following components by weight: 2-ethylhexyl acrylate, vinyltrimethoxysilane, 1-methyl-1-phenylethyl hydroperoxide, vinyl-terminated silicone resin, di-t-butyl cumene peroxide, fluorosiloxane, ethyl acetate, ethylene glycol dimethyl ether, a toughening agent, polysiloxane-polyether copolymer, silicone and wax powder. In the invention, the peel strength is reduced; it is ensured that the release force of the cold laminating film is not affected by the external environment, such that the cold laminating film has good stability; and meanwhile the subsequent adhesion of the release layer is improved, so that it can ensure that the adhesive force of the adhesive layer would not be affected after long-term adhesion between the adhesive layer and the release layer.

### TECHNICAL FIELD

The invention belongs to the field of adhesive tape technology, and, specially relates to an ultra-quiet backing-paper-free cold laminating film.

### BACKGROUND

Cold laminating films are protective materials laminated onto photographs and pictures by a manual or automatic cold laminator. Conventional cold laminating films have a layer of release paper. During rolling up, problems like impressions, creases, bubbles, etc. may occur due to the unevenness of backing paper. Moreover, the use of backing paper will consume the natural resources of trees, leading to a burden on the environment, and also increases the manufacturing cost and cleaning workload of the factory. Therefore, backing-paper-free cold laminating films are popularized. Meanwhile, the backing-paper-free cold, laminating films feel good, and have some extensibility, thus having a wider range of application. However, the backing-paper-free cold laminating films still have a defect that bubbles are easy to occur during the laminating process if the peel strength is too high. Therefore, how to develop a cold laminating film with low peel strength and a stable peel force has become the research direction of those skilled in the art.

### SUMMARY

An objective of the present invention is to provide an ultra-quiet backing-paper-free cold laminating film which reduces the peeling strength, ensures that the release force of the cold laminating film is not affected by the external environment, and has good stability, so that bubbles will not appear during the laminating process.

In order to achieve the above purpose, the technical solution as used in the present invention is: an ultra-quiet backing-paper-free cold laminating film comprising a substrate layer, a release layer, and an adhesive layer, the release layer and the adhesive layer being each attached to a respective side of the substrate layer, the release layer being obtained by drying a release agent applied on the substrate layer, and the release agent consisting of the following components by weight:

50-75 parts of 2-ethylhexyl acrylate,

10-30 parts of vinyltrimethoxysilane,

0.5-1.5 parts of 1-methyl -1-phenylethyl hydroperoxide,

20-30 parts of vinyl-terminated, silicone resin,

2-5 parts of di-t-butyl cumene peroxide,

1-3 parts of fluorosiloxane,

30-50 parts of ethyl acetate,

50-80 parts of ethylene glycol dimethyl ether,

2-8 parts of a toughening agent,

1-3 parts of polysiloxane-polyether copolymer,

0.2-0.5 parts of silicone, and

1-3 parts of wax powder.

Further improved technical solutions of the above technical solution are as follows:

1. In the above solution, the toughening agent is one of polybutadiene rubber, nitrile-butadiene rubber, or styrene-butadiene rubber.

2. In the above solution, the substrate layer is a BOPP substrate, a PET substrate, or a CPP substrate.

3. In the above solution, the substrate layer is a CPP substrate.

4. In the above solution, the substrate layer (1) has a thickness of 25-100 μm.

5. In the above solution, the release layer (2) has a thickness of 1-5 μm.

Due to the use of the above technical solution, the present invention has the following advantages as compared with the prior art:

By adding di-t-butyl cumene peroxide and fluorosiloxane into 2-ethylhexyl acrylate, vinyltrimethoxysilane, 1-methyl-1-phenylethyl hydroperoxide and vinyl-terminated silicone resin, the ultra-quiet backing-paper-free cold laminating film of the present invention reduces the peel strength, ensures that the release force of the cold laminating film is not affected by the external environment, has good stability, improve the residual adhesion, and can ensure that the adhesive force of the adhesive layer will not be affect after the long-term adhesion between the adhesive layer and the release layer.

### BRIEF DESCRIPTION OF DRAWINGS

FIG. 1 is a schematic structural view of the ultra-quiet backing-paper-free cold laminating film of the present invention.

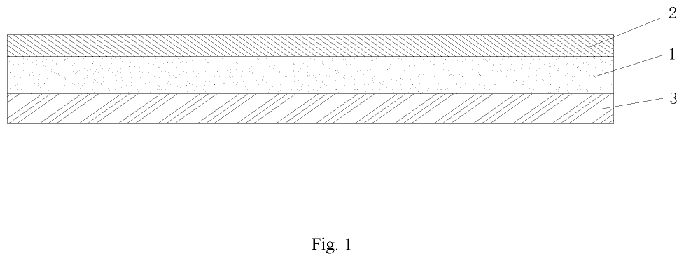

In the accompanying drawing: 1. Substrate layer; 2. Release layer; 3. Adhesive layer.

### DETAILED DESCRIPTION

In the description of the present invention, it should be noted that, descriptions relating to orientation, for example, orientation or positional relationships indicated by “center”, “up”, “down”, “left”, “right”, “vertical”, “horizontal”, “inside”, “outside”, etc. are based on the orientation or positional relationships shown in the accompanying drawings, and are to, facilitate the description of the present invention and simplify the description only, rather than indicating or implying, that the device or element referred to must have a specific orientation or be constructed and operated in a specific orientation, and therefore cannot be construed as limiting the present invention; and the terms “first”, “second” and “third” are for the purpose of description only and should not be construed as indicating or implying relative importance. In addition, the terms “mount”, “engage”, and “connect” should be interpreted in a broad sense unless, explicitly defined and limited otherwise, which, for example, can mean a fixed connection, a detachable connection or an integral connection; can mean a mechanical connection or an electrical connection; and can mean a direct connection, an indirect connection by means of an intermediary, or internal communication between two elements. For those of ordinary skill in the art, the specific meaning of the terms mentioned above in the present invention should be construed to specific circumstances.

Hereinafter, the present invention will be further described with reference to examples.

Examples 1-4: An ultra-quiet backing-paper-free cold laminating film comprising a substrate layer 1, a release layer 2, and an adhesive layer 3, the release layer 2 and the adhesive layer 3 are each, attached to a respective side of the substrate layer 1, the release layer 2 is obtained by drying the release agent applied on the substrate layer 1, and the release agent consists of the following components by weight, as shown in Table 1:

TABLE 1

| | Example | Example | Example | Example |
|---|---|---|---|---|
| Components | 1 | 2 | 3 | 4 |
| 2-ethylhexyl acrylate | 50 parts | 60 parts | 70 parts | 75 parts |
| vinyltrimetho xysilane | 15 parts | 10 parts | 30 parts | 25 parts |
| 1-methyl-1-phenylethyl | 0.5 parts | 1 part | 1.5 parts | 0.8 parts |
| hydroperoxide | | | | |
| vinyl-terminated silicone | 20 parts | 25 parts | 22 parts | 30 parts |
| resin | | | | |
| di-t-butyl cumene peroxide | 2 parts | 3 parts | 5 parts | 2.5 parts |
| fluorosiloxane | 2.5 parts | 1 part | 1.5 parts | 3 parts |
| ethyl acetate | 30 parts | 50 parts | 40 parts | 35 parts |
| ethylene glycol dimethyl | 60 parts | 55 parts | 80 parts | 50 parts |
| ether | | | | |
| toughening agent | 2 parts | 5 parts | 8 parts | 6 parts |
| polysiloxane-polyether | 1 part | 2 parts | 3 parts | 1.5 parts |
| copolymer | | | | |
| silicone | 0.2 parts | 0.5 parts | 0.3 parts | 0.4 parts |
| wax powder | 3 parts | 1.9 parts | 2.5 parts | 1 part |

In Example 1, the toughening agent is polybutadiene rubber, the above substrate layer is a BOPP substrate, the above substrate layer has a thickness of 25 μm, and the above release layer has a thickness of 1 μm.

In Example 2, the toughening agent is styrene-butadiene rubber, the above substrate layer is a PET substrate, the above substrate layer has a thickness of 50 μm, and the above release layer has a thickness of 2 μm.

In Example 3, the toughening agent is nitrile-butadiene rubber, the above substrate layer is a CPP substrate, the above substrate layer has a thickness of 100 μm, and the above release layer has a thickness of 3 μm.

In Example 4, the toughening agent is polybutadiene rubber, the above substrate layer is a CPP substrate, the above substrate layer has a thickness of 80 μm, and the above release layer has a thickness of 5 μm.

The method of preparing the above ultra-quiet backing-paper-free cold laminating film is as follows:

50-75 parts of 2-ethylhexyl acrylate, 10-30 parts of vinyltrimethoxysilane, 0.5-1.5 parts of 1-methyl-1-phenylethyl hydroperoxide, and 30-50 parts of ethyl acetate were added into a reactor, and the reaction mixture was stirred and heated for 2-4 hrs;

20-30 parts of vinyl-terminated silicone resin, 2-5 parts of di-t-butyl cumene peroxide, 1-3 parts of fluorosiloxane, 50-80 parts of ethylene glycol dimethyl ether, and 0.2-0.5 parts of silicone were added into the reactor, and stirred for 1-3 hrs;

the, reactor was cooled to room temperature, 1-3 parts of polysiloxane-polyether copolymer, 2-8 parts of the toughening agent, and 1-3 parts of the wax powder were added, stirred for 0.5 firs, and discharged to obtain the release agent;

the release agent was uniformly applied onto the substrate layer 1, and dried to obtain the release layer 2.

Comparative Examples 1 and 2: An ultra-quiet backing-paper-free cold laminating film comprising a substrate layer 1, a release layer 2, and an adhesive layer 3, the release layer 2 and the adhesive layer 3 being, each attached to a respective side of the substrate layer 1, the release layer 2 being obtained by drying the release agent applied on the substrate layer 1, and the release agent consisting of the following components by weight, as shown in Table 2:

TABLE 2

| | Comparative | Comparative |
|---|---|---|
| Components | Example 1 | Example 2 |
| 2-ethylhexyl acrylate | 50 parts | 60 parts |
| vinyltrimethoxysilane | 15 parts | 10 parts |
| 1-methyl-1-phenyl ethyl | 0.8 parts | 1 part |
| hydroperoxide | | |
| vinyl-terminated silicone resin | 30 parts | 25 parts |
| di-t-Butyl cumene peroxide | — | 3 parts |
| fluorosiloxane | 2.5 parts | — |
| ethyl acetate | 30 parts | 40 parts |
| ethylene glycol dimethyl ether | 60 parts | 80 parts |
| toughening agent | 2 parts | 8 parts |
| polysiloxane-polyether copolymer | 3 parts | 2 parts |
| silicone | 0.3 parts | 0.4 parts |
| wax powder | 2.5 parts | 1 part |

The preparation method of the comparative example is the same as that of the examples.

The performances of the cold laminating films prepared by Examples 1 to 4 and Comparative Examples 1 and 2 are shown in Table 3.

TABLE 3

| | | | | Comparative | |
|---|---|---|---|---|---|
| | Examples | | | Examples | |
| Test items | 1 | 2 | 3 | 1 | 2 |
| Release force at | 35 | 38 | 36 | 90 | 105 |
| room temperature | | | | | |
| (g/in) | | | | | |
| Release force when | 38 | 40 | 38 | 120 | 150 |
| aging at 70° C.(g/in) | | | | | |
| Residual adhesion | 93 | 95 | 96 | 75 | 62 |
| (%) | | | | | |

Test method:

Test method for release force: A TESA7475 adhesive tape with a width of 25 mm and a length of 200 mm was taken and applied onto a test surface of the film, i.e., the release sutface, and rolled back and forth three times by a standard rolling roller (note: the adhesive tape should be applied under rolling, to avoid bubbles from occurrence between the adhesive tape and the release surface, which will affect the test accuracy); the adhesive tape stood for 20 minutes after application was completed, and the temperature and the humidity of the laboratory were controlled at 25 ±3° C. and 50±10 RH%, respectively then, a double-sided adhesive tape was applied to the non-test surface of the sample, which was fixed onto a standard steel plate for testing. The material was mounted in a clamp, and tested with a tensile machine by the method of stretching the test tape at a 180-degree angle, the data displayed by the tensile machine computer is the release force (On) of the test piece, and an average value of 5 values is taken as the test result.

Test method of residual adhesion rate: The TESA7475 tape was applied to the release surface of the release film for a period of time, peeled off from the release surface of the release film, and then tested for its adhesion value, which was set as B; and the TESA7475 adhesive tape was not applied to the release surface of the release film, but directly tested for its adhesion value, which was set as A, then the residual adhesion rate =(B/A)* 100%.

As shown by the evaluation results in Table 3, the release force of the ultra-quiet backing-paper-free cold laminating film in the examples is low and stable, and has relatively small change under environmental influence, which does not affect the peeling effect; while the residual adhesion is high, and would not affect the viscosity of the adhesive after long-term adhesion with the adhesive layer.

The above examples are merely intended to illustrate the technical concept and features of the present invention, the purpose thereof is to enable those skilled with the technology to understand the contents of the present invention and implement accordingly, and the protection scope of the present invention should not be limited thereto. Any equivalent change or modification according to the spirit of the present invention shall be encompassed within the protection scope of the present invention.

1. An ultra-quiet backing-paper-free cold laminating film comprising a substrate layer (1), a release layer (2), and an adhesive layer (3), the release layer (2) and the adhesive layer (3) being each attached to a respective side of the substrate layer (1), the release layer (2) being obtained by drying a release agent applied on the substrate layer (1), and the release agent consisting of the following components by weight:
50-75 parts of 2-ethylhexyl acrylate,
10-30 parts of vinyltrimethoxysilane,
0.5-1.5 parts of 1-methyl-l-phenylethyl hydroperoxide,
20-30 parts of vinyl-terminated silicone resin,
2-5 parts of di-t-butyl cumene peroxide,
1-3 parts of fluorosiloxane,
30-50 parts of ethyl acetate,
50-80 parts of ethylene glycol dimethyl ether,
2-8 parts of a toughening agent,
1-3 parts of polysiloxane-polyether copolymer,
0.2-0.5 parts of silicone, and
1-3 parts of wax powder.

2. The ultra-quiet backing-paper-free cold laminating film of claim 1, wherein the toughening agent is one of polybutadiene rubber, nitrile-butadiene rubber or styrene-butadiene rubber.

3. The ultra-quiet backing-paper-free cold laminating film of claim 1, wherein the substrate layer (1) is a BOPP substrate, a PET substrate, or a CPP substrate.

4. The ultra-quiet backing-paper-free cold laminating film of claim 3, wherein the substrate layer (1) is a CPP substrate.

5. The ultra-quiet backing-paper-free cold laminating film of claim 1, wherein the substrate layer (1) has a thickness of 25-100 μm.

6. The ultra-quiet backing-paper-free cold laminating film of claim 1, wherein the release layer (2) has a thickness of 1-5 μm.

7. A preparation method of the ultra-quiet backing-paper-free cold laminating film of claim 1, comprising:
Step One: adding 50-75 parts of 2-ethylhexyl acrylate, 10-30 parts of vinyltrimethoxysilane, 0.5-1.5 parts of 1-methyl-1-phenylethyl hydroperoxide, and 30-50 parts of ethyl acetate into a reactor, and stirring and heating the mixture in the reactor for 2-4 hours;
Step Two: adding 20-30 parts of vinyl-terminated silicone resin, 2-5 parts of di-t-butyl cumene peroxide, 1-3 parts of fluorosiloxane, 50-80 parts of ethylene glycol dimethyl ether, and 0.2-0.5 parts of silicone into the reactor, and stiffing the mixture in the reactor for 1-3 hours;
Step Three: cooling the reactor to room temperature, adding 1-3 parts of polysiloxane-polyether copolymer, 2-8 parts of the toughening agent, and 1-3 parts of the wax powder into the reactor, stirring the mixture in the reactor for 0.5 hours, and discharging to obtain a release agent; and
Step Four: applying the release agent uniformly onto a substrate layer, and drying the applied release agent to obtain a release layer.

8. The preparation method of the ultra-quiet backing-paper-free cold laminating film of claim 1, wherein
the heating in Step One is conducted at a temperature of 80±3° C.
